(19) United States
(12) Patent Application Publication
(10) Pub. No.: US 2009/0007473 A1
(43) Pub. Date: Jan. 8, 2009

(54) DISPLAY WITH BANNER CONNECTION SYSTEM AND BANNER

(75) Inventors: Dixon Gimpel, Prior Lake, MN (US); Joe Skull, Fridley, MN (US); Curtis H. Lindblom, Oakdale, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: SKYLINE DISPLAYS, INC., Eagan, MN (US)

(21) Appl. No.: 11/968,535

(22) Filed: Jan. 2, 2008

Related U.S. Application Data
(60) Provisional application No. 60/878,477, filed on Jan. 3, 2007.

(51) Int. Cl. G09F 17/00

(52) U.S. Cl. 40/604

(57) ABSTRACT

An exhibit or display for tradeshows or the like having a plurality of support members and a banner that can include an elongate attachment member or banner strip presented or disposed thereon that can be used to selectively operably couple and decouple the banner with a channel in one of the plurality of support members or in a channel member portion included in a channel portion in one of the plurality of support members.

### RELATED APPLICATION

The present application claims the benefit of U.S. Provisional Application No. 60/878,477, filed Jan. 3, 2007, which is incorporated herein in its entirety by reference.

### FIELD

The present invention is related generally to exhibits. More particularly, the invention relates to exhibits for tradeshows and the like having support members and banners that can be selectively included with the support members utilizing a banner connection system and member.

### BACKGROUND

Tradeshow exhibits often include a plurality of support members, such as tubular components, and graphic banners or sheets. The banners can be included to add functionality to the exhibits or incorporate graphics to attract or inform tradeshow attendees.

Banners on conventional tradeshow exhibits generally include a sheet of material with a pocket or loop created at the ends thereof. The pockets are created by overlapping or looping the banner upon itself and adding a stitch thereto. To place the banners on the tubular components, those assembling exhibits slide the pockets onto tubular components prior to or during assembly.

Because the graphical banners generally must be placed on the tubular components prior to or during assembly, assembly can require a substantial amount of pre-planning to determine the order in which the exhibit is to be assembled. Such order often can not be deviated from to make sure that the banners are placed onto the tubular components at the appropriate time. For example, during assembly, if a tubular component is selectively fixed at both ends to other tubular components before a banner is placed thereon, then the components generally has to be at least partially disassembled and the banner placed on the components. This can add further assembly time to the exhibit set-up. Further, because the banners generally have fixed dimensions, the tubular components have to be placed on the exhibit accordingly and often can not be adjusted after the banners have been placed thereon.

Also, if an exhibitor desires to place any components at an intermediate location of the tubular components having a banner already disposed thereon, such as a light fixture or additional tubular component, it might be necessary to cut open a portion of the pocket and/or banner to enable access to the tubular component. This can damage or destroy the banners.

To remove or change the banners from the framework, the exhibit usually must be at least partially disassembled to free an end of the tubular component, such that the banner can be slid off of an end thereof. However, if an exhibitor desires to remove or change a banner during the tradeshow, such disassembly might not be feasible given the requisite tools, timeframe, or the limited space available.

There is therefore a need for an improved exhibit and graphic banner overcoming the deficiencies of conventional designs.

### BRIEF SUMMARY

The exhibits according to the various embodiments overcome the deficiencies of conventional designs. A banner includes an elongate attachment member attached thereto that can be used to selectively operably couple the banner with a channel portion in one of the plurality of support members. The graphical banners can be placed on the tubular components prior to, during, or after assembly manually without requiring tools. As a result, assembly does not require as much pre-planning, tools, or labor as can be required with conventional designs.

Further, because the graphic banners extend from a channel included on the support members, if an exhibitor desires to place any components at an intermediate location of the tubular components having a banner placed thereon, it is not necessary to cut open the banner to enable access to the tubular component as can be required with conventional designs. Also, to remove or change the graphic banners from the framework, the exhibit does not have to be disassembled. Rather, the graphic banners can be removed, adjusted, or changed while the framework remains assembled.

A feature and advantage of certain embodiments of the invention is that the banners may be easily installed and removed by unskilled personnel without the use of tools. The banner may be installed by inserting on end of the elongate attachment member in a slot defined in a channel portion of a frame member and continually urging balance of the attachment member in the slot progressively pressing in the attachment member down the length of the attachment member towards and to the opposite end. Insertion may be facilitated by pushing inwardly on the tab portion that extends out of the recess.

A feature and advantage of certain embodiments of the invention is that polymer members providing channel portions having slots may be inserted into channels in tubular support members to provide a defined slot size for receiving elongate attachment members of banners. Thus, existing frameworks for comprising support members of existing tradeshow displays may be modified to utilize the banners of the invention herein. Moreover, tubular support members having elongate channels extending axially on a plurality of sides of said support members can utilize the banners of the invention to connect the banner from any of the elongate channels.

A feature and advantage of certain embodiments of the invention is that the banners of certain embodiments of the invention may be attached without separate fasteners, without tools, and without rigid fasteners.

A feature and advantage of certain embodiments of the invention is that a flexible handle portion of an attachment member extends outwardly from the channel in which the connection portion of the attachment member is captured thereby providing an easily accessible portion of the attachment member to grasp to remove the attachment member from a slot or channel in a support member.

A feature and advantage of certain embodiments of the invention is that the attachment member of the banner has a constant cross section permitting extrusion of the component. The component may have a configuration in the cross section of three protrusions which may present a simple y-shaped configuration.

A feature and advantage of certain embodiments of the invention is that a support member having multiple elongate channels may be provided and attachment of the banner can be positioned to wrap the flexible sheet portion of the banner around the outer surface of the elongate support member.

A feature and advantage of certain embodiments of the invention is a banner with an attachment member extending the length of a linear edge of a flexible sheet portion, the attachment member configured as a strip with oppositely extending edge portions and edge portion tips and a tab extending outwardly from the strip intermediate the edge portion tips.

### BRIEF DESCRIPTION OF THE DRAWINGS

FIG. 1 is a front perspective view of an exhibit comprising a plurality of vertical and horizontal support members and a banner presented thereon;

FIG. 2a is a cross-sectional view of the support members of FIG. 1 according to a first embodiment depicting channels therein;

FIG. 2b is a cross-sectional view of the support members of FIG. 1 according to a second embodiment depicting channels therein;

FIG. 3 is a perspective view of a support member of FIGS. 1 and 2a, wherein an elongate attachment member coupled to the banner is engaged with a channel portion member presented in a channel included in the support member;

FIG. 4 is a cross-sectional view of the channel portion of FIG. 3;

FIG. 5a is an end view of the channel portion member of FIG. 3 prior to being flexed inwardly;

FIG. 5b is an end view of the channel portion member of FIG. 3 after being flexed inwardly;

FIG. 6 is an end perspective view of the elongate attachment member of FIG. 3;

FIG. 7 is fragmentary end view of the support member of FIG. 3 prior to the engaging of channel portion member thereto;

FIG. 8 is fragmentary end view of the support member of FIG. 3 after the engaging of channel portion member thereto;

FIG. 9 is fragmentary end view of the support member of FIG. 3 prior to the engaging of the elongate attachment member with the channel portion member;

FIG. 10 is fragmentary end view of the support member of FIG. 3 after the engaging of the elongate attachment member with the channel portion member;

FIG. 11 is a fragmentary end view of a support member according to a second embodiment after the engaging of an elongate attachment member with a channel portion;

FIG. 12 is a schematic view of the support member of FIG. 11;

FIG. 13 is an end perspective view of a support member having a plurality of banners, each engaged with a channel portion member in a channel portion of the support member; and

FIG. 14 is an end perspective view of a support member having a banner and elongate attachment member directly engaged with a channel portion of the support member.

### DETAILED DESCRIPTION OF THE DRAWINGS

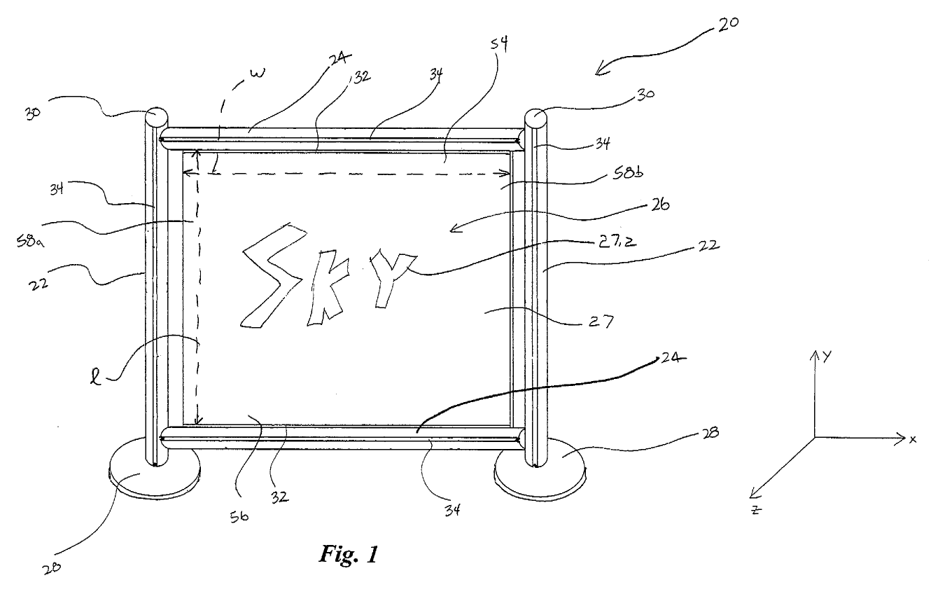

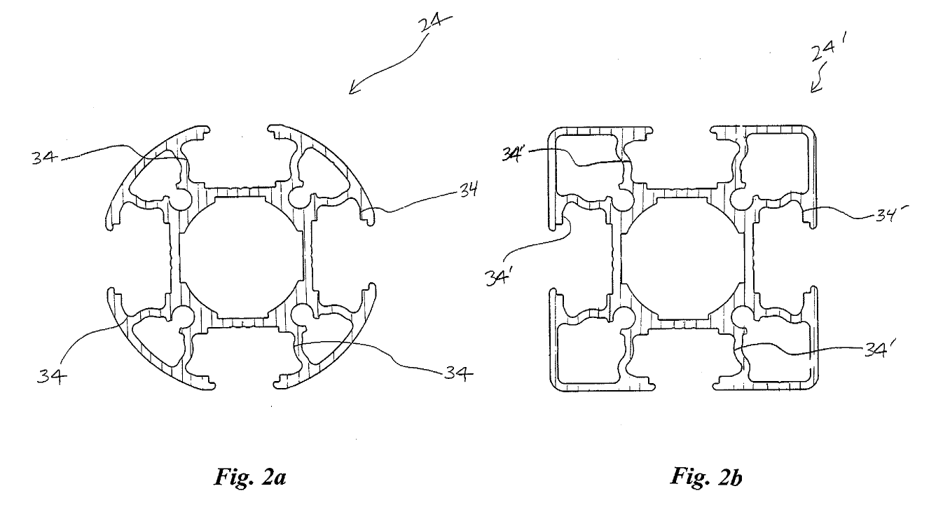

Referring to FIG. 1, an exhibit or display 20 according to an embodiment generally includes a plurality of vertical and horizontal support members, such as tubular extruded components, and one or more banners 26 presented therewith. Specifically, as depicted in FIG. 1, display 20 comprises two generally parallel vertical elongate support members 22, two generally parallel horizontal elongate support members 24 having optional bases 28 at a bottom and optional end caps 30 at a top, and banner 26 presented intermediate support members 22, 24, selectively operably coupled to channel portions included on horizontal support members 24. Cross sectional views of exemplary vertical and horizontal support members 22, 24 are depicted in FIGS. 2a and 2b. “Channel” and “channel portion” when used herein does not specify a specific configuration such as a three walls defining a recess; rather the channel is an elongate recess and can have a complex cross-sectional configuration, for example as illustrated in the Figures. Generally, “channel portion” or “channel structure” as used herein, is the physical structure defining the channel.

Tubular components 22, 24 can be extruded metal, such as aluminum, but those skilled in the art will recognize that other materials, such as extruded thermoplastics, can be used. Those skilled in the art will also recognize that other support member shapes and configurations can be used. Banners 26 include sheet portion 27 that can be cloth, such as polypoplin, but those skilled in the art will recognize that other materials, such as polymer sheets, can be used. Graphics 27.2 may be on the sheet portion and can be indicia, photos, art work, etc. Banners 26 can include one or more elongate attachment members or graphic banner strips thereon or therewith for ease of coupling banner 26 with the support members 22, 24. Elongate attachment members 32 can be a flexible thermoplastic, such as semi-rigid poly vinyl chloride (“PVC”), but those skilled in the art will recognize that other materials can be used.

Referring again to FIG. 1, banner 26 generally includes a top edge portion 54, a bottom edge portion 56, and a pair of generally opposed side edge portions 58a, 58b. The banner has a width w and a length l. Each of top and bottom edge portions 54, 56 can include an elongate attachment member 32 preferably extending a length equivalent to or greater than the width w of the banner and attached to the banner for ease of selectively operably coupling banner 26 with channel portions included on one or two horizontal support members 24. Banner 26, channel portions, and elongate attachment members 32 are described in further detail below. Those skilled in the art will recognize that other, more complex exhibit configurations can be assembled utilizing the various components as depicted and described herein. Examples of such configurations are depicted and described in U.S. Pat. No. 7,024,834 and U.S. Patent Publication No. 2006/0242923, which are incorporated herein by reference in their entirety.

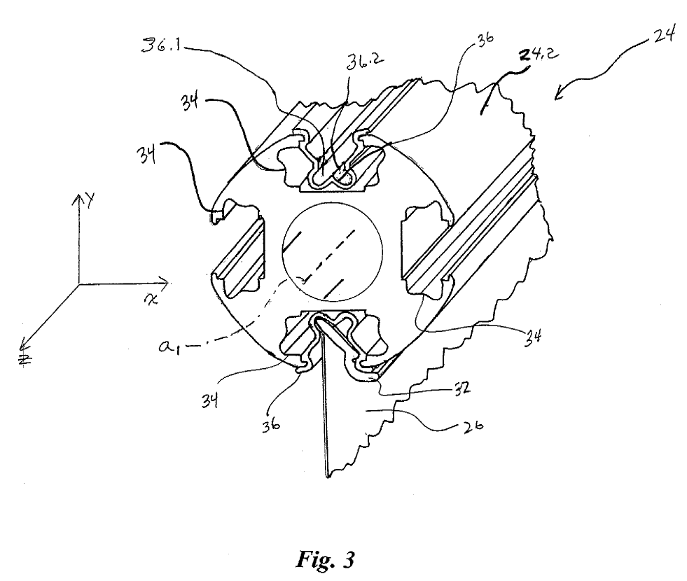

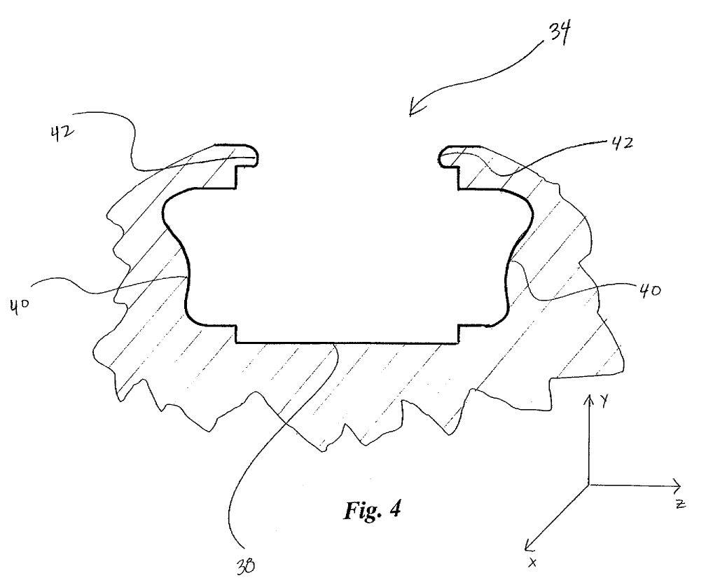

Referring to FIG. 3, a cross-sectional, close-up view of the interaction and coupling between tubular component 24 and banner 26 is depicted. Tubular component 24 (also depicted in FIGS. 2a and 2b) can include one or more channel portions 34 defining channels 34.1 therein. Channel portions 34 can be included, for example, for coupling tubular components 22, 24 together and for coupling accessories and other components to tubular components 22, 24. Referring to FIG. 4, channel portions 34 generally comprise a base 38, a pair of sidewalls 40, and a pair of channel lips 42, each lip 42 projecting inwardly into channel 34.1 from sidewalls 40. Those skilled in the art will recognize that other channel shapes and configurations can be used. Those skilled in the art will also recognize that less than four or more than four channels can be included on support members 22, 24.

Referring again to FIG. 3, tubular component 24 has an axis al, an outer peripheral surface 24.2 and can further include one or more optional selectively removable slotted inserts or channel members 36, each channel member 36 being operably within a channel 34.1. The insert illustrated has a pair of slots 36.1, 36.2 for receiving an elongate attachment member of a banner 26 to thereby securing the banner to the tubular component 22, 24 as described in further detail below.

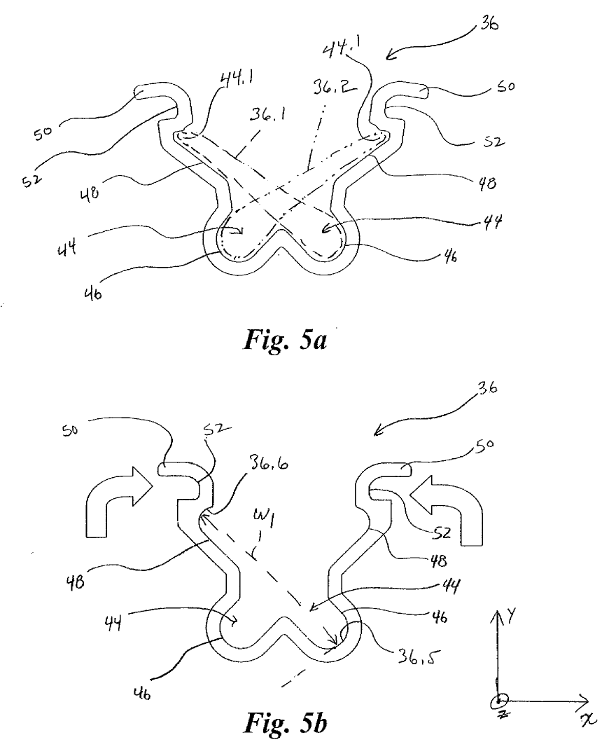

Referring to FIGS. 5a and 5b, insert or channel portion member 36 generally has a pair of elongate lower or inner attachment member recesses or first grooves 44 defined by a first, lower groove portion 46. Second upper groove portions 48 define second grooves. Additionally, outer attachment recesses or grooves 44.1 in combination with lower recesses form slots 36.1, 36.2 to capture and retain elongate attachment member 32 when engaged with channel member 36. Slots have a major dimension, a length that extends the length of the tubing, and a secondary dimension from concave portion 36.5 to concave portion 36.6 a distance w1.

The insert or channel member 36 illustrated further includes a pair of outwardly projecting flanges 50 and lip recesses 52 extending inwardly therebelow generally corresponding with channel lips 42 included on channel 34. As depicted by FIGS. 5a and 5b, channel member 36 can be flexible, such as in the “x” direction along the “z” axis, so as to enable flanges 50 to be pinched or pressed together to narrow the cross section of channel member 36. Specifically, FIG. 5a depicts channel member 36 prior to being flexed and FIG. 5b depicts channel member 36 after being flexed. Channel member 36 can be an extruded thermoplastic, such as rigid PVC, but those skilled in the art will recognize that other materials can be used. Those skilled in the art will also recognize that other channel member shapes and configurations can be used.

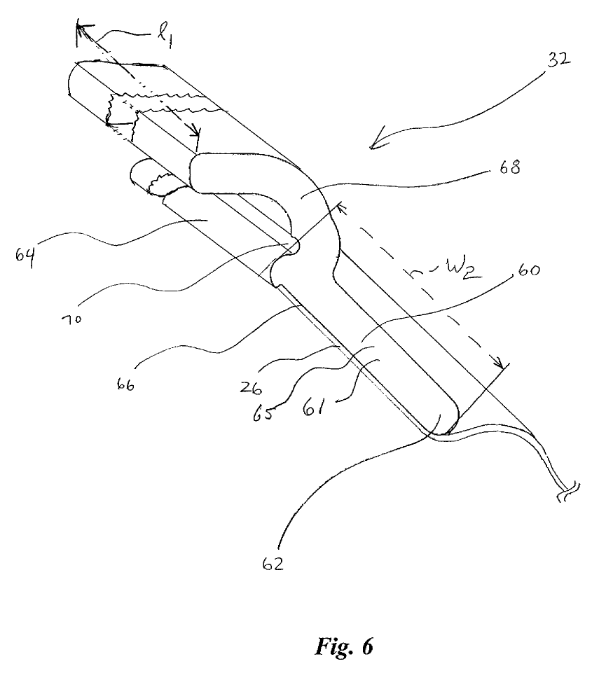

Referring to FIG. 6, elongate attachment member generally comprises a banner connection portion 60 extending a major dimension a length l1 and comprising an engagement portion 61 having a first end 62, a second end 64, and a midportion 65 therebetween. The engagement portion 61 is preferably resiliently flexible and has a secondary dimension, a width w2 measured between the first end and the second end. A banner recess 66 may be defined in the engagement portion. The first and second ends and midportion extend the length of the elongate attachment member. Elongate attachment member 32 can further include a tab 68 and a cutout 70, cutout 70 thereon enabling flexing of tab 68 relative to banner connection portion 60 that can operably flex the engagement portion altering the width w2 facilitating insertion into the slot. Banner 26 can be coupled and fixed to elongate attachment member 32 by placing an edge of banner 26 in banner recess 66 and adhering or coupling banner 26 thereto using double-sided tape or other fastening mechanism, such as stitching, an adhesive, or plastic welding.

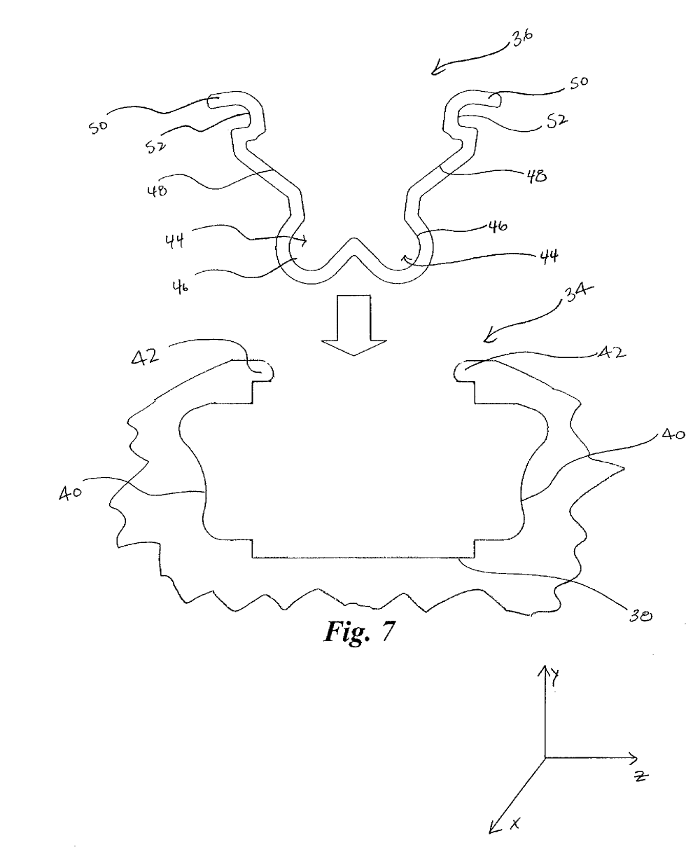

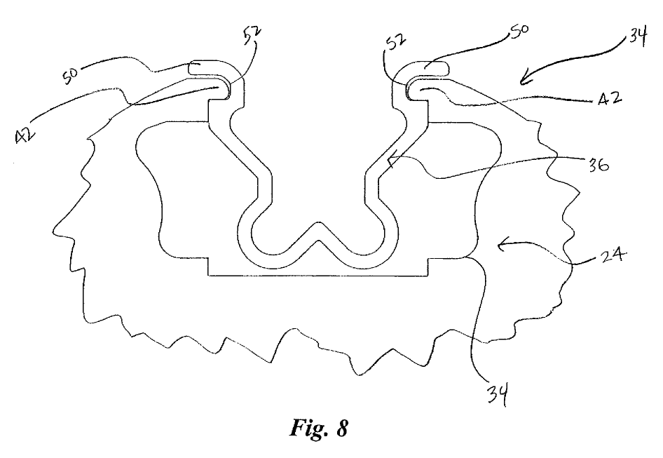

Referring to FIGS. 7 and 8, to selectively couple banner to tubular component 24, channel member 36 is first coupled with channel 34 in tubular component 24. To do so, a portion of channel member 36 is pressed into channel 34, such that it generally snaps or fits into place. To aid in coupling channel member 36 with channel 34 in tubular component 24, flanges 50 can be pressed inwardly such that channel member 36 can fit into channel 34 in tubular component 24 and flanges 50 can then be released. Flanges 50 can rest on lips 42 of channel 34 and lips 42 can interfit lip recesses 52 on channel member 36 to retain channel member 36 in channel 34. The general bias of channel member 36 outwardly to its original shape can further cause channel member 36 to be retained in channel 34. Once the portion of channel member 36 is pressed into channel 34, such that it snaps or fits into place, a user can slide along, or progressively push in the member along the length of channel member 36, such as along flanges 50 of channel member, until the entire length of channel member 36 is coupled and retained in channel 34.

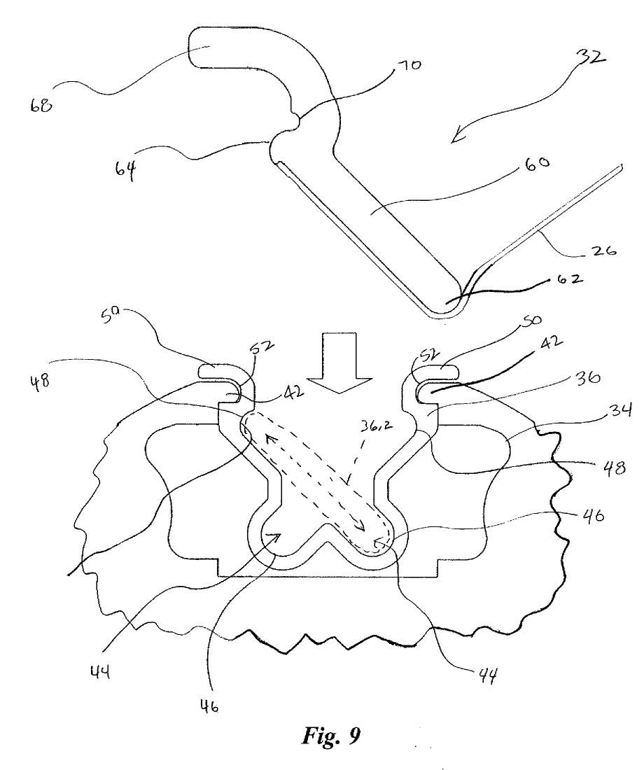

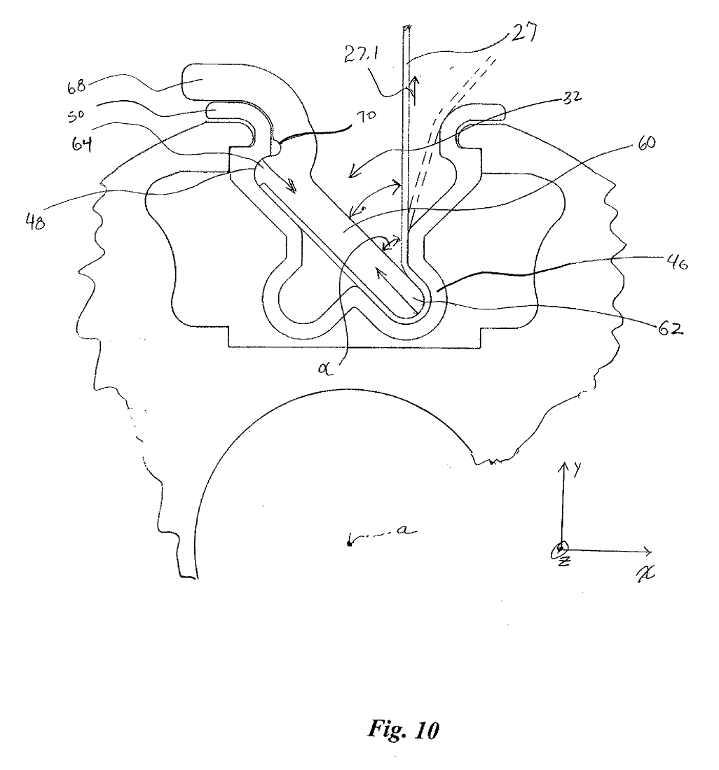

Referring to FIGS. 9 and 10, once channel member 36 is coupled to and retained in channel 34, elongate attachment member 32 having banner 26 coupled thereto can be placed into channel member 36. First end 62 having banner 26 thereon can be inserted into deeper first portion 46 of one of elongate attachment member slots 36.2 such that sheet portion 27 is sandwiched intermediate first end 62 and first portion 46 of elongate attachment member recess 44 (FIG. 10). Second end 64 can then be pushed into place in second portion 48 of elongate attachment member recess 44 and tab 68 can rest on flange 50 of channel member 36. Second end 64 can deflect just enough to slide into second recess 48, but return to its original shape once within second recess 48 such that second end 64 is at least partially captured by second recess 48. The elongate attachment member snuggly fits into the slot such as by an interference fit. The resiliency of the elongate member preferably puts the member into a slight compression that retains the member within the slot. Moreover, as the sheet portion 27 of the banner is put into tension as illustrated by the arrow 27.4, the elongate attachment member is further put into compression in a direction perpendicular to the length of the member. The deeper recess 46 retains the end of the engagement portion 61.

Once a portion of elongate attachment member 32 is pressed into channel member, such that it generally snaps or fits into place, a user can slide along the length of elongate attachment member 32, such as tab 68 on elongate attachment member 32, until the entire length of elongate attachment member 32 is coupled and retained in channel member 36. In this position, elongate attachment member 32 and banner 26 are locked into channel member 36 and therefore tubular component 24. Elongate attachment member 32 and banner 26 can remain locked into channel member 36 regardless of forces being placed on banner 26 in directions away from channel member 36. For example, when banner 26 is pulled in a direction generally away from channel member 36, first end 62 is deep enough in first groove 46, such that it will not be pulled out of first groove 46. The forces on banner 26 are such that they will generally not be on second end 64, thus second end 64 also remains retained in second groove 48. When banner 26 is pulled in a direction generally away from support member 24, forces generated on connection portion 60 are focused primarily on first end 62 and are absorbed primarily at first groove 46 without releasing said first end. Further, because forces generated on connection portion 60 are focused primarily on first end 62, the tape or adhesive junction between elongate attachment member 32 and the end of banner 26 can be less affected by the forces. The forces on second end are in the direction of the width of the engagement portion and therefore do not dislodge or displace the second end from the upper concave portion.

To remove elongate attachment member 32 from channel member 36, a portion of tab 68 of elongate attachment member 32 can be pulled away from flange 50 of channel member 36 to remove banner connection portion 60 of elongate attachment member 32 from elongate attachment member recess 44. By so doing, second end 64 will be deflected just enough to slide out of second groove 48. Once this is done, elongate attachment member 32 can removed from channel member 36. This can be done along the length of elongate attachment member 32 from one end of elongate attachment member 32 to another until entire length of banner connection portion 60 of elongate attachment member 32 is removed from elongate attachment member recess 44 and from channel member 36. The attachment member, peels away from the channel.

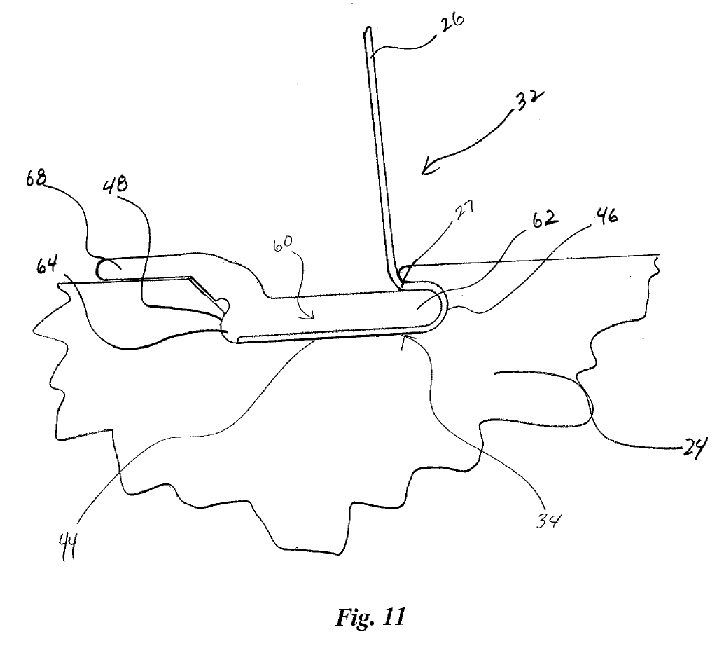

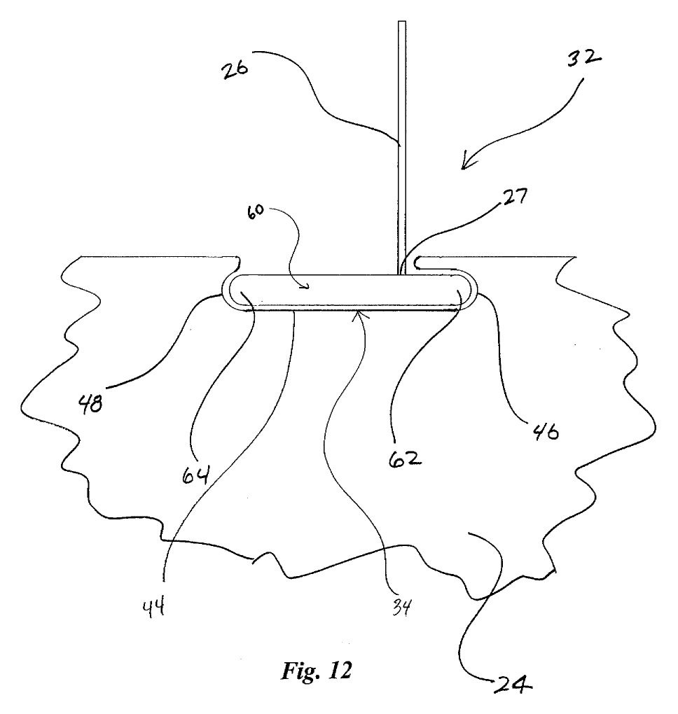

Referring to FIGS. 11 and 12, in another embodiment, channel 34 is included in support member 24 and is generally parallel to the outer surface of the support member 24 and not in an angular relationship into the support member 24, such as is depicted in FIG. 10. In this embodiment, channel comprises a first groove 46 and a second groove 48, wherein first groove 46 is deeper and/or longer than second groove 48. Such a configuration can enable channel 34 to capture and retain elongate attachment member 32 when engaged with channel member 36. Specifically, to capture and retain elongate attachment member 32, banner 26 is generally coupled or positioned proximate first end 46 of elongate attachment member 32 at a banner/member connection point 27. Once a first portion of elongate attachment member 32 is pressed into channel 34, such that it generally snaps or fits into place, a user can slide along the length of elongate attachment member 32, such as tab 68 on elongate attachment member 32, until the entire length of elongate attachment member 32 is coupled and retained in channel 34. In this position, elongate attachment member 32 and banner 26 are locked into channel 34 and therefore tubular component 24.

Elongate attachment member 32 and banner 26 can remain locked into channel 34 regardless of forces being placed on banner 26 in directions away from channel 34. For example, when banner 26 is pulled in a direction generally away from channel 34, first end 62 is retained enough in first groove 46, such that it will not be pulled out of first groove 46. The forces on banner 26 are such that they will also not be placed on second end 64, thus second end 64 also remains retained in second groove 48. When banner 26 is pulled in a direction generally away from support member 24, forces generated on connection portion 60 are focused primarily on first end 62 at least partially captured by first groove 46.

Banner 26 can be coupled at any position along the length of the elongate attachment member 32. However, as the banner/member connection point 27 moves away from the first end 62 captured by the deeper first groove 46 towards the shallower second groove 48, forces on the banner 26 in a direction generally away from the support member 24 can cause the second end 64 to disengage from the second groove 48. Further, when the elongate attachment member 32 is constructed of a generally flexible material, when the banner/member connection point 27 is proximate the center of the length of the elongate attachment member 32, forces on the banner 26 in a direction generally away from the support member 24 can cause the elongate attachment member 32 to flex or bend, thus removing the second end 64 and/or first end 62 from the second or first grooves 46, 48, respectively. Thus, it can be desirable for the banner/member connection point 27 to be proximate the first end 62 captured by the deeper first groove 46.

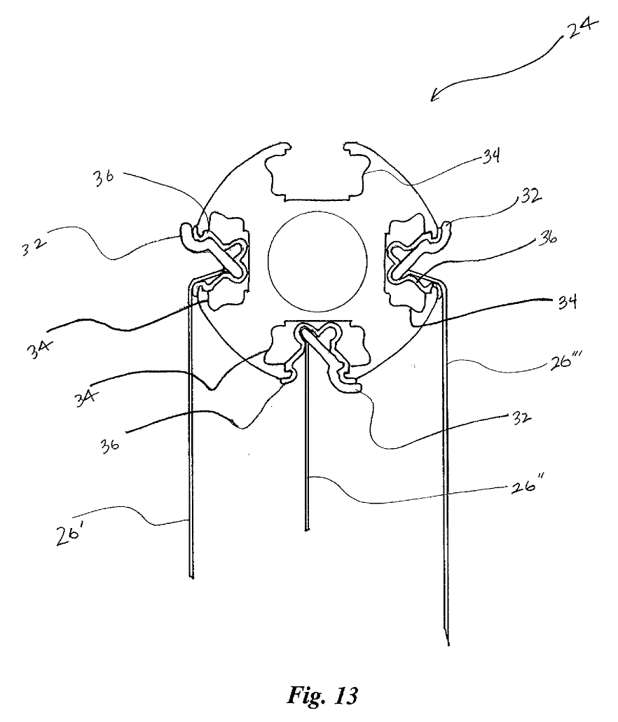

Referring to FIG. 13, in an embodiment, more than one banner 26′, 26″, 26′″ are coupled to tubular component, such as a first, front banner 26′, a second, middle banner 26″, and a third, rear banner 26′″. In this configuration, one or more of first and second banners 26′, 26″ can be at least partially transparent such that graphics included on third banner 26′″ are at least partially visible through first and second banners 26′, 26″. In further embodiments, banners are included in two channels. In other embodiments, banners are included in all four channels. In yet further embodiments, tubular member 24 can comprise any number of channels, wherein each of the channels can comprise an optional banner presented therein. The banners can extend in a parallel direction to each other or can extend in different directions. In certain embodiments, the banner can attach to an upwardly facing channel above eye level and wrap around the tubular member to extend downwardly. This conveniently offers a smooth upward termination to the banner with the actual attachment to the tubular member, as well as the tubular member hidden from view on the side of the member where the banner extends downwardly. In certain embodiments, more that one sheet can be attached to an elongate attachment member that couples in a channel.

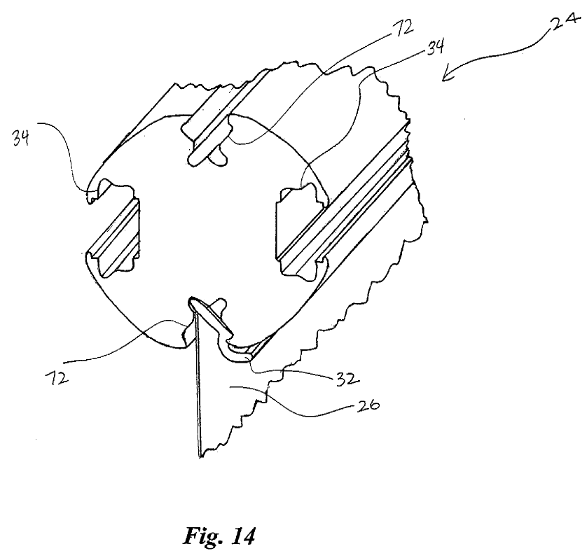

Referring to FIG. 14, in an embodiment, tubular member 24 can comprise channels 34 and channel members 36 as described above. Tubular member 24 can further include further channels 72 comprising shapes generally corresponding with channel members 36 as described above. In this embodiment, elongate attachment member 32 on banner 26 can be directly coupled to channels 72 without the need for a channel member 36 in the channel. In further embodiments, elongate attachment members 32 can be configured to couple channel 34 as depicted and described herein.

The embodiments above are intended to be illustrative and not limiting. Additional embodiments are within the claims. In addition, although the display and banner magnets have been described with reference to particular embodiments, those skilled in the art will recognize that changes can be made in form and detail. Any incorporation by reference of documents above is limited such that no subject matter is incorporated that is contrary to the explicit disclosure herein.

What is claimed is:

1. A display for tradeshows and the like comprising:
a framework comprising a plurality of rigid support members, at least one of the support members comprising a channel portion presented therein, the channel portion defining a connection member receiving recess including a first groove and a generally parallel second groove, the grooves facing one another and spaced by a separation distance; and
a banner comprising a flexible sheet portion with graphics thereon and an elongate attachment member, the flexible sheet portion having an edge with a resilient elongate attachment member attached thereto, the resilient elongate attachment member comprising a connection portion with first edge portion and a parallel second edge portions sized to be removably captured within the connection member receiving recess, wherein the first edge portion is positioned in the first groove and the second edge portion is positioned in the second groove to anchor the banner relative to the at least one of the support members.

2. The display of claim 1, wherein a portion of the flexible sheet is pinched intermediate the channel portion portion and the elongate attachment member.

3. The display of claim 1, wherein the channel portion comprises a base, the recess being angled inwardly into the channel portion, such that the first groove is proximal the base and the second groove is distal the base.

4. The display of claim 1, wherein the first groove is deeper than the second groove, such that when a force is placed on the banner in a direction generally away from the support member, the first groove retains the first end of the connection portion therein.

5. The display of claim 1, wherein the first groove is deeper than the second groove and wherein the banner is coupled to the elongate attachment member proximal the first end and distal the second end, such that when the banner is pulled in a direction generally away from the support member, forces generated on the connection portion are focused primarily upon the first end.

6. The display of claim 1, further comprising a tab on the elongate attachment member proximate the second end of the connection portion, such that when movement of the tab is effected in a direction away from the support member, the second end is disengaged from the second groove.

7. The display of claim 1, further comprising a channel portion member selectively engaged with the support member to define the channel portion.

8. The display of claim 1, further comprising.
a second channel portion presented in the at least one of the support members; and
a second banner having a second elongate attachment member proximate an end of the second banner, the second elongate attachment member comprising a second connection portion and the second channel portion comprising a second recess therein, wherein the second connection portion is at least partially captured by the second groove to anchor the second banner relative to the at least one of the support members.

9. The display of claim 8, wherein the banner comprises a graphic presented thereon and the second banner comprises transparency, such that the graphic is visible through the second banner.

10. The display of claim 1, wherein the support member comprises a tubular component.

11. A method of connecting a banner to a display comprising:
providing a framework comprising a plurality of support members, wherein at least one of the support members comprises a channel portion presented therein along a length thereof, the channel portion comprising a recess therein including a first groove and a generally opposed second groove;
providing a banner having an elongate attachment member proximate an end of the banner, the elongate attachment member comprising a connection portion comprising first and second ends; and
anchoring the banner relative to the at least one of the support members by at least partially capturing the first end by the first groove and at least partially capturing the second end by the second groove.

12. The method of claim 11, further comprising capturing at least a portion of the end of the banner intermediate the channel portion and the elongate attachment member.

13. The method of claim 11, further comprising providing a channel portion member and selectively presenting the channel portion member with the support member to define the channel portion.

14. The method of claim 11, wherein the elongate attachment member comprises a tab along the length thereof, the step of anchoring the banner to the at least one of the support members further comprising sliding along the tab along the length of the elongate attachment member.

15. The method of claim 14, further comprising removing the banner from the at least one of the support members by effecting movement of the tab relative the channel portion to remove the elongate attachment member from channel portion.

16. A display for tradeshows and the like comprising:
a framework comprising a plurality of support means, at least one of the support means having a channel portion means presented therein along a length thereof, the channel means comprising a recess therein including a first groove and a generally opposed second groove; and
display means having coupling means proximate an end of the display means, the coupling means comprising a connection means comprising first and second ends, wherein the first end is at least partially captured by the first groove and the second end is at least partially captured by the second groove to anchor the display means relative to the at least one of the support means.

17. The display of claim 16, wherein at least a portion of the end of the display means is at least partially captured intermediate the channel means and the coupling means when the display means is anchored relative to the at least one of the support means.

18. The display of claim 16, wherein the channel means is selectively disengageable with the support means.

19. The display of claim 16, wherein the support means comprises a tubular component.

20. A display for tradeshows and the like comprising:
a framework comprising a plurality of support members, at least one of the support members having a channel presented therein; and
a banner having an elongate attachment member proximate an end of the banner, at least a portion of the banner being sandwiched intermediate the channel and the elongate attachment member to anchor the banner relative to the at least one of the support members.

21. A banner for a tradeshow display or the like comprising a piece of flexible sheet material having a straight edge, the piece of flexible sheet material having with graphics disposed thereon, the, a flexible resilient extrusion fixedly attached to the piece of flexible sheet material at the straight edge.

22. The banner of claim 21 wherein the straight edge of the piece of flexible sheet material is a first edge and the piece of flexible sheet material has a second straight edge opposite the first straight edge, and wherein the first straight edge also has a flexible resilient extrusion fixedly attached thereto.

23. A component for a banner for attachment of the banner to a rigid support member having a channel therein, the component comprising an elongate extrusion of a resilient polymer, the extrusion having a constant cross sectional configuration comprising a y-shaped configuration in the cross-section with three tips, two of the tips comprising a connection portion for being received in the channel, the third tip comprising a tab for facilitating insertion and removal of the banner.

24. A method of manufacturing a banner for a tradeshow display comprising the steps of:
cutting flexible sheet material into a rectangular shaped piece,
printing graphics on the sheet material,
extruding an attachment member having a connection portion comprising two oppositely extending protrusions, each protrusion having a tip, and having a tab intermediate the two tips of the oppositely extending protrusions, the protrusion having a length and a constant cross sectional configuration down the entire length of the protrusion, and
attaching the attachment member to an edge of the rectangular shaped piece.

25. The method of claim 24 further comprising the step of attaching an additional extrusion member to an additional edge of the rectangular shaped piece.
